(19) United States
(12) Patent Application Publication
(10) Pub. No.: US 2014/0263675 A1
(43) Pub. Date: Sep. 18, 2014

(54) CUSTOMIZABLE GREETING CARD, SYSTEM, AND METHOD FOR PROVIDING SAME

(71) Applicant: Robert Dale Beadles, Lodi, CA (US)

(72) Inventor: Robert Dale Beadles, Lodi, CA (US)

(21) Appl. No.: 14/216,878

(22) Filed: Mar. 17, 2014

Related U.S. Application Data
(60) Provisional application No. 61/801,098, filed on Mar. 15, 2013.

(51) Int. Cl. G06K 19/06; G06K 1/12; G09F 1/06

(52) U.S. Cl. CPC G06K 19/06046; G09F 1/06; G06K 1/12
USPC 235/494

(57) ABSTRACT

Greeting cards, systems and methods for a greeting card system use a greeting card that can comprise at least one sheet of material, the sheet being foldable from a flat configuration into a self standing greeting card in which a folded print or print portion stands substantially upright from a folded base portion, and at least one code carried on the at least one sheet, wherein the at least one code comprises an access code for accessing an associated electronic greeting media stored on an electronic device of the greeting card system.

### RELATED APPLICATIONS

The present application claims benefit of U.S. Provisional Patent Application No. 61/801,098, filed Mar. 15, 2013, the entire contents of which are incorporated by reference herein as if fully set forth.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

Embodiments relate to greeting cards, and more particularly but not exclusively, to greeting cards which are portable, and personalize-able. Embodiments also relate to software applications and methods for greeting cards systems including such greeting cards.

### BACKGROUND

Pre-printed greeting cards are known to be manufactured and sold, typically at retail establishments, to assist individuals in exchanging greetings with others. Such greeting cards typically have a construction primarily of paper or paper-like materials and typically include a message and artwork of some type. Many greeting cards include plenty of space for customization, such as for allowing a sender to write a personal message in handwriting directly on the greeting card.

Greeting cards typically have a theme which correlates with some event which might typically call for the sending of a greeting card. Examples include birthdays, holidays, anniversaries, illnesses, graduations, etc. In addition to the theme associate with the card, cards also can be distinguished in other ways, such as with some cards being humorous and other cards being more sentimental or serious.

Because of the many different types of greetings and the many different particular tastes and styles enjoyed by different individuals, an exceptionally large number of greeting cards must be inventoried at stores if “just the right card” is to be provided for the purchaser. In many instances, multiple aisles of a store are devoted to the display of such cards.

Greeting cards are typically exchanged and enjoyed for a very brief period of time and then typically thrown away.

There is therefore a need to provide improved greeting cards and greeting card systems that have more user-friendly features and more distributor friendly features.

### SUMMARY

According to one aspect, there is a greeting card for a greeting card system provided. The greeting card can comprise at least one sheet of material, the sheet being foldable from a flat configuration into a self standing greeting card in which a folded print or print portion stands substantially upright from a folded base portion, and at least one scannable code carried on the at least one sheet, wherein the at least one scannable code comprises an access code for accessing an associated electronic greeting media stored on an electronic device of the greeting card system.

According to embodiment, the base portion comprises at least one foldable end portion of the at least one sheet; wherein the at least one foldable end portion is foldable to a supporting position having a plane at substantially 90 degrees to the plane in which the fold printed or print portion extends such that in use, the folded support portion lays substantially flat on a planar horizontal surface and supports the printed or print portion of the at least one sheet in substantially vertical upright position.

According to another aspect, there is a greeting card system provided. The greeting card system can comprise at least one sheet of material, the sheet being foldable from a flat configuration into a self standing greeting card in which a folded print portion stands substantially upright from a folded base portion, and at least one scannable code carried on the at least one sheet, wherein the at least one scannable code comprises an access code for accessing an associated electronic greeting media stored on an electronic device of the greeting card system; and a controller configured to receive from a user device the access code and use the code to retrieve and transmit the electronic media associated with the card to the user device.

According to one embodiment, controller is further configured to receive the access code and associate the received access code with the electronic greeting media for the retrieval in response to receiving in the controller user entered instructions.

According to yet another aspect, a method for a greeting card system is provided. The greeting card method comprises configuring at least one sheet of material to be foldable from a flat configuration into a self standing greeting card in which a folded print portion stands substantially upright from a folded base portion, providing at least one scannable code on the at least one sheet, wherein the at least one scannable code comprises an access code; associating, by a computer processor system, an electronic greeting media with the scannable code; receiving, by the computer processor system, from a user device the access code; using, by the computer processor system, the received code to retrieve and transmit the electronic media associated with the card to the user device.

According to another aspect, there is provided a computer apparatus. The apparatus can comprise: at least one processor operably connectable to at plurality of user devices; a data bus coupled to the at least one processor; a computer-usable medium embodying computer program code, the computer-usable medium being coupled to the data bus; and the computer program code comprising instructions executable by the processor and configured for performing computer associated processes of the aforesaid method for greeting card system.

A computer-usable medium for the above greeting card system, the computer-usable medium embodying computer program code, the computer program code comprises computer executable instructions configured for performing computer associated processes of the aforesaid method for greeting card system.

### BRIEF DESCRIPTION OF THE DRAWINGS

The following detailed description of the preferred embodiment of the present invention will be better understood when read in conjunction with the appended drawings. For the purpose of illustrating the invention, there are shown in the drawings embodiments that are presently preferred. It is understood, however, that the invention is not limited to the precise arrangements and instrumentalities shown. In the drawings:

FIG. 1 illustrates a plan view taken from above of an exemplary unfolded sheet in a flat configuration of a greeting card system according to one embodiment;

FIG. 2 illustrates a side view of the sheet of FIG. 1 folded into a self standing greeting card according to one embodiment;

FIG. 3 illustrates a plan view taken from above the self standing greeting card of FIG. 2; and

FIG. 4 illustrates a back side view of the card shown in FIGS. 2 & 3;

FIG. 5 illustrates a front side view of the card shown in FIGS. 2 & 3;

FIG. 6 illustrates an exemplary network in which a controller of the greeting card system can be implemented according to one embodiment;

FIG. 7 illustrates a flow chart of a method for the greeting card system including the controller of FIG. 6;

FIG. 8 is a schematic diagram illustrating exemplary software modules for implementing the greeting card system according to one embodiment; and

FIGS. 9 and 10 are schematic diagrams showing exemplary general computer hardware components of a greeting card server and user device, respectively, according to one embodiment.

### DETAILED DESCRIPTION OF THE PREFERRED EMBODIMENTS

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Technical features described in this application can be used to construct various embodiments of methods and apparatus for greeting card systems.

Reference will now be made to the drawings in which the various elements of embodiments will be given numerical designations and in which embodiments will be discussed so as to enable one skilled in the art to make and use the invention.

Referring to FIGS. 1-5 of the accompany drawings, a greeting card system has a sheet 15 of material and a scannable code 7 carried on the sheet of material. The sheet of material is configured to be foldable into a self standing

greeting card 1 in which a print portion 2,3 of the sheet stands substantially upright from a base portion 4,5 of the sheet. Examples of such sheet material are paper, plastic or a combination thereof. Print portion referred to herein means a print receiving portion, a printed portion or a combination thereof. In the example of FIG. 1, the sheet material is configured to by foldable into the self standing greeting card 1 by providing fold lines 16 in the sheet material in an arrangement such that the sheet material is foldable along the fold lines into the self standing greeting card.

The print portion 2,3 is configured to receive print information associated with the card and may be pre-printed with some or all of the print information. The scannable code 7 is a mobiletag bar code for accessing an electronic greeting media associated with the greeting and stored on an electronic device. In one example, a UPC code 8 is also carried on the sheet 15.

By providing a greeting card in the form of a flat sheet that is foldable into a self standing greeting card in which the print portion of the sheet stands substantially upright from a base and providing a scannable access code on the sheet for accessing stored electronic greeting media associated with the greeting card, the greeting card is both user and distributor friendly. The greeting card can be made extremely small and self standing, perfect for home and office display. Stores can use existing display clips for hanging the unfolded flat card sheets, such as those used for holding bags of chips, the plastic clips that hang down for holding several items in a row. The customer can simply pull the unfolded sheet from the clip and place the sheet into their basket for purchase. No packaging of any kind may be needed, no other display requirements.

Referring in more detail to the greeting card sheet shown in FIGS. 1-3, In one embodiment, the one or more pre-fold lines 16 are arranged to enable the sheet to be folded from a flat configuration in which the sheet is substantially flat and easily storable into the self standing greeting card configuration in which the print portion 2,3 of the sheet stands substantially upright from the base portion of the sheet. In the flat configuration, greeting card information 6, such as greeting pictures and messages, can be easily printed on sheet 15 using regular printing apparatus that may be commercial printers or personal printers. Sheet 15 can be pre-printed with all of the greeting information prior to sale or some or all of the greeting information can be added to the sheet by the consumer using their own printer.

In one embodiment, the sheet has spaced apart fold lines traversing the width of the sheet and dividing the sheet into a plurality of side by side panels. The inner panels are foldable together about the fold line therebetween to form a single flat section having a front face and back face. The end panels are foldable outwardly in opposite directions at substantially 90 degrees to the single flat section to form a substantially planar base portion for maintaining the single section upright.

In one example, sheet 15 is an elongated sheet and has spaced apart fold lines 16 traversing the width of the sheet and dividing the sheet into an array of panels. For example, as shown in FIG. 1, the rectangular sheet 15 has traversing fold lines dividing the sheet into four side by side sheet panels 2,3,4,5. The four side by side sheet panels are made up of a base panel 4,5 at each end of the sheet, and a pair of inner panels 2,3 between the two base panels. In the particular example of FIG. 2, the two inner panels 2,3 are of equal size and foldable together about the fold line 16 therebetween such that they form a single flat section 10 having a back face and a front face as shown in FIGS. 4 & 5, respectively. One or both of the front face and back face of the sheet can be preprinted with greeting images 6. The base panels 4,5 at opposite ends of the sheet are also of equal size and foldable about respective fold lines outwardly in opposite directions to occupy a plane substantially perpendicular to the plane of the single flat section 10 and form a planar base 11 for placing on a planar surface and supporting the flat section substantially upright. In this example, the panels are rectangular however in other examples they can be square or other shapes. Also, in this example the inner panels are longer than the base panels but in other examples the base panels can be the same length or even longer than the inner panels.

Whilst the sheet in FIG. 1 is shown as being rectangular shaped, in other examples other shaped sheets are envisaged. In other examples, any shaped sheet can be adopted, and folding lines placed in any arrangement, such that the sheet can be folded from a flat configuration in which the sheet is substantially flat and easily storable into the self standing greeting card configuration in which the print portion of the sheet stands substantially upright from the base portion of the sheet.

In other non-limiting examples, the foldable sheet of FIG. 1 is of a shape different a different shape, such as for example triangular, square or other shape. Also, in other non-limiting examples, the pre-folded sheet has spaced apart fold lines in positions different from those shown in FIGS. 1-3 and dividing the sheet into more or less sections than that shown in FIGS. 1-3.

In one embodiment, the greeting card system includes an electronic greeting controller capable of retrieving the stored electronic media associated with the greeting card 1 using the access code scanned or otherwise obtained from the greeting card. In one embodiment, the controller is provided by means of a software greeting card application module running on a computer system. The computer system processes data in accordance with instructions of the greeting card system module to perform processes described herein with reference to one or more embodiments. The electronic greeting associated with the greeting card and stored on a storage device is retrieved using the access code. Storage device is any storage device capable of being accessed by the computer system. In non-limiting example, storage device is one or more data storage devices configured to be accessed by one or more data processors, such as computer servers. Non-limiting examples of data storage devices are disk drives, computer memory and the like.

In one embodiment, the software greeting card application module running on a server or other processor is accessible over a computer network via one or more user electronic devices. A non-limiting example of a user electronic device is programmable machine such as personal computer, mobile computer, server or workstation. Non-limiting examples of personal computers are desktop computers. Non-limiting examples of mobile computers are laptop computers, tablet computers, mobile phones, such as but not limited to smartphones, personal digital assistants, and wearable computers. The software greeting card application is configured to provide a user interface that is accessible to the user device via a browser application or other suitable means running on the user electronic device.

Embodiments of the aforesaid greeting card controller may be practiced in many different environments. One possible example of such a computer network environment is shown in FIG. 6. By way of example, greeting card controller 705 may be implemented on at least one network server site in conjunction with at least one user processor apparatus 701,702, such as but not limited to camera devices; image scanning devices; mobile telephone devices; smart phone devices; tablet devices, portable processor devices; personal Computer (PC) devices; surveillance devices. The network server site (see for example website server of FIG. 6) may be provided within a network which, for preference, is the Internet, but equally can be any one of, combination of, or interconnection of, but not restricted to: a local area network (LAN); a wide area network (WAN): a home network; and a wireless network. The user processor apparatus communicates with the network server site over a telecommunication network and/or Internet etc.

In one embodiment, the greeting card controller, such as server 705, is configurable by a user to generate a personal greeting card message associated with the greeting card and access code carried on the card. In one example, the greeting card controller is configurable to receive a customized electronic greeting card message from a user device, such as user device 701,702, receive and associate the access code with the message and store this information for subsequent retrieval by a user device utilizing the access code scanned from the greeting card. In this manner, a user purchasing the card can easily customize an electronic greeting card message and associate that message with the greeting card and access code carried thereon and the recipient of the card can subsequently obtain the access code from the card and use it to retrieve the customized electronic greeting card message.

A method for a greeting card system according to one embodiment will now be described with reference to the flow chart illustrated in FIG. 7. Method 600 begins by providing the greeting card sheet 16 (process 601). Let us assume that a user wishing to send a greeting card has purchased the greeting card sheet 16 in flat configuration. The greeting card sheet may include pre printed greeting information. Alternatively or additionally, the user can print a personalized greeting picture and message on the sheet using a printer. The user then accesses the greeting card controller/server site over the Internet via a web browser or smartphone app on the user's device, such as a mobile smartphone. The user may have already a user account set up with greeting card system site or may generate one upon accessing the site. The greeting card server accesses the user account (process 602). The user scans the mobiletag bar code, provided on the greeting card sheet, with a mobile smartphone scanner application which may be integrated in or external from the greeting card system. The server receives the mobiletag code scanned from the greeting card sheet from the user device (process 603).

In another example, the access code provided on the card may be alphanumeric number that is readable by a user without scanning into the user device, the user reads the code from the card sheet, inputs the alphanumeric code manually into the user device and the server receives the access code read from the card.

The server receives a user generated digital greeting to be associated with the access code (process 604). The user generates a digital greeting message such as audio, video, text message or a combination thereof utilizing the user device. The digital message can be generated by the greeting card system software application running on the server in response to receiving user instructions from the user device over the internet, or can be generated independently of the greeting card system and then uploaded to the greeting card server from the user device. In this manner, the user can very easily personalize the greeting card sheet message that the user wishes to send in a way that is not possible with conventional greeting cards.

The server associates the generated digital message with the scanned mobiletag code and the digital message is stored in a location that is indexable by the code for subsequent retrieval (process 605).

In one embodiment, the greeting cards software application can offer a user interface to the user device to enable the user to select and/or create greeting images/text for printing on the greeting card sheet before sending the card to the recipient. In one example, these images can be pre-determined by the system. In another example, the greeting card system generates a user interface that enables the user to select and/or create greeting images/text that correspond to at least some of the digital greeting message that the system received and used in process 604/605. For example, in the case of the a video greeting, the greeting card system module can include speech recognition components that analyze speech data contained in the digital video greeting and generate words corresponding to words from the speech data for use in printing on the greeting card. In response to user instructions, the system selects/generates such greeting images/text, corresponding in some way to the received digital greeting card message, and provide this in a format for retrieval and printing by the user. In this manner, the user can further personalize the card by not only generating a digital greeting message for retrieval by the card recipient, but also by enabling the user to easily print a greeting image/text on the greeting card sheet which is consistent with the greeting information contained in the digital message associated with the greeting card. In other examples, the greeting card system can use pre-determined greeting card digital messages, and also pre-determined corresponding greeting image/text for printing.

The user then provides the greeting card sheet to the intended recipient by sending by regular mail or providing by hand etc. The recipient upon having received the sheet can then fold the sheet to form the self standing greeting card. The greeting card system server then receives over the internet from their user device instructions from the recipient to access the system, for example via a website. The recipient, using a smartphone, or other suitable device, scans the mobiletag code carried on the greeting card. The scanned mobiletag code is then received by the greeting card system server over the Internet from the user device (process 606). In response to receiving the code or other user instructions, the greeting card server then indexes the digital greeting message previously personalized by the sender of the card (process 607) and sends over the internet the digital message to the recipients user device for viewing and any playback (process 608). The recipient is then able to access on their user device the sent digital message generated by the sender so as to complete the personal greeting card experience.

In yet another embodiment, the greeting card sheet print portion is an erasable print portion. The printed information on the print portion is erasable by suitable means, such as but not limited by wiping off the printed ink or other print material on the printed portion with a wet cloth or a chemical remover. The recipient can then reuse the card by generating his or her own new digital greeting message (as a user, see process 600) and use the greeting card system user interface to associate the new digital greeting message to the greeting card access code. In doing so, the system also disassociates the previous digital message from the access code. In one example, generates greeting image/text consistent with the newly generated digital message and transmit this to the user device of the recipient (now the new user) for printing on the greeting card. The process 600 then continues in respect of the new user. In this manner, the greeting card system enables the greeting card experience to be entirely customized by the new user reusing the greeting card.

In yet another embodiment, the print portion of the greeting card for the greeting card printed message is omitted substantially or entirely and the scannable code provides the entire greeting information.

Reference will now be made to exemplary computer hardware configurations for the aforementioned greeting card computer systems. In one embodiment, the greeting card computer system may be implemented using a greeting card server having a general hardware configuration for example, as shown in, but not limited to, FIG. 8. There may one server or a plurality of interconnectable servers, which may be physically located locally and/or remotely. Greeting card server 800 has a central processor unit (CPU) or other processor 801, operable to execute one or more programs, including the greeting card application module under the control of program software provided in memory 802, such as random access memory (RAM), and also in a storage memory 803, such as a disc drive. The storage memory 803 and the memory 802 are also available to the processor unit 801 as temporary or permanent storage of results and data. A network interface 807 is coupled to the processor unit 801 and permits communication between the processor unit 801 and local and/or external network devices over a network. One or more data buses 808 interconnect the greeting card server 800 components shown in FIG. 9.

Processor unit 801 is coupled to receive input from one or more input devices that may be, but not limited to, a pointing device 806, such as a mouse, pad or touch screen and a text input device 805, such as a keyboard or touch screen. Other input devices capable of receiving human-entered input selections for locally setting up and operating the greeting card system can be adopted, in addition or in place of devices 805, 806, such as a voice controller module. The processor unit 801 also drives a display 804 that displays images and provides sounds, as controlled and provided by the processor unit 801. Alternatively, one or more of the input devices 805, 806 may be omitted and the server can be set up via remotely connected devices.

The user devices referred to herein are data processing units, such as mobile phones, smart phones, computer notebooks, tablet devices and shopping kiosk processing units, or other types of computerized devices capable of performing the functionality of the user devices as referred to in the embodiments described herein. Each user device may be the same or different from another user device.

The computerized user devices having a general hardware configuration for example, shown in, but not limited to, FIG. 10. Each user device 701, 702 has a processor unit 712, memory 713, storage 715, display 717, network interface 720 and input devices 718, 719. Input devices may be: a pointing device 719, which may be for example a mouse, pad or touch screen, and a text input device 718, such as a keyboard or touch screen. In one example, the user device includes code read/write hardware and interface 716 for enabling reading of the code. These components are interconnected via data bus connections 714. The processor unit 712 may be a Central processor unit (CPU) or other processor circuitry operable to execute one or more programs, including a client-user application module under the control of program software provided in memory 713, such as random access memory (RAM), or in a storage memory 715, such as a disc drive. The storage memory 715 and the memory 713 are also available to the processor unit 712 as temporary or permanent storage of results and data. Network interface 720 is coupled to the processor unit 712 and permits communication between the processor unit 712 and the greeting card server 800 and with any other user devices over network.

Application greeting card software modules can include instructions for performing computer-implemented operations described herein, such as for example but not limited to the computer-implemented processes employed in process 600. One example of the computer software for the greeting card system will now described for the purpose of operating the greeting card system of embodiments described herein. An exemplary computer software configuration according to one embodiment is depicted in block diagram form in FIG. 8. Software system 800 has a greeting card application module, which is stored in system storage/memory. The software system can include a kernel or operating system and a shell or interface. One or more application programs or modules, such as the greeting card application module, may be “loaded” (i.e. transferred from storage into memory for execution by the processor). The system receives user commands and data through user interface; these inputs may then be acted upon by the greeting card server, in accordance with instructions from an operating module and/or application module.

Note that the term “module” as used herein may refer to a collection of routines and data structures that perform a particular task or implements a particular abstract data type. Modules may be composed of two parts: 1) an interface that lists the constants, data types, variable, and routines that can be accessed by other modules or routines and 2) an implementation that is typically private, accessible only to that module, and includes source code that actually implements the routines in the module. The term “module” may also simply refer to an application, such as a computer program design, to assist in the performance of a specific task.

In the non-limiting example shown in FIG. 8, greeting card applications module can include a user interface 705, content programmer module 706, user account manager 707, recipient alert manager 708, and content providing manager 709.

The software system can include databases, libraries, and other indexes or searchable data storage systems for storing data, including, for example, user profile data, birthdates, anniversaries, administration data and authentication data. Such databases and other storage systems can be stored in storage/memory, which can be located locally or remotely from the processor. In the example of FIG. 8, the software system 750 also includes user databases, libraries and/or other storage systems that store data associated with the system. In particular, the software system has a content database 710 and a delivery database 711. Either or both of the aforementioned databases may be located locally, or remotely and accessible over the Internet or cloud network.

Software system 700 also includes a user device software system 725, which is loadable or pre-loaded on the user device and has a user application module 703 and browser 704 module that enables the server to provide content generation on the user devices. In one non-limiting example, the greeting card user interface is implemented as an interactive Web page that is provided by the greeting card application server to the user device for display through a Web browser. Also as shown in FIG. 8, the user application includes optionally a code reader module.

The software system described and shown in FIG. 8 is just one example of the software configuration for performing the greeting card content generation process of the described embodiments. Other software configurations are envisaged for performing the same functionality and/or other functionality of the described embodiments, with or without all modules that are capable of providing the greeting card content functionality of the embodiments.

In various embodiments, the software system can be implemented as a client or as a server, or both as client and server. In other embodiments, other architecture is envisaged for implementing the greeting card software, such as peer-to-peer architecture.

Greeting card systems of one or more embodiment create a cost effective, very miniature, portable, personalize-able greeting card that saves tremendous time and money in locating and purchasing the appropriate card. It also takes up 25% the space or less of a traditional greeting card allowing store owners and distributors far more space for other products. In one example, a miniature greeting card is provided that that is perfect for all occasions and uses while saving time and money for the buyer and shelf space for the store owner.

The greeting card system is extremely easy to produce requiring very standard printing practices allowing for minimal costs in producing multitudes of such “Mini Plays” at extremely low prices.

Specific reference to components, process steps, and other elements are not intended to be limiting. Further, it is understood that like parts bear the same reference numerals, when referring to alternate Figures. It will be further noted that the Figures are schematic and provided for guidance to the skilled reader and are not necessarily drawn to scale. Rather, the various drawing scales, aspect ratios, and numbers of components shown in the Figures may be purposely distorted to make certain features or relationships easier to understand.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A greeting card for a greeting card system comprising
at least one sheet of material, said sheet being foldable from a flat configuration into a self standing greeting card in which a folded print or print portion stands substantially upright from a folded base portion, and
at least one code carried on said at least one sheet,
wherein said at least one code comprises an access code for accessing an associated electronic greeting media stored on an electronic device of said greeting card system.

2. The greeting card of claim 1, wherein said base portion comprises at least one foldable end portion of said at least one sheet; wherein said at least one foldable end portion is foldable to a supporting position having a plane at substantially 90 degrees to the plane in which the fold printed or print portion extends such that in use, said folded support portion lays substantially flat on a planar horizontal surface and supports said printed or print portion of said at least one sheet in substantially vertical upright position.

3. The greeting card of claim 1, wherein the at least one code includes a portion that is only readable by a scanning device.

4. The greeting card of claim 3, wherein the scanning device is selected from the group consisting of: a camera device; an image scanning device; a mobile telephone device; a smart phone device; a tablet device, a portable processor device; a personal Computer (PC) devices; and a surveillance device.

5. A greeting card system comprising
at least one sheet of material, said sheet being foldable from a flat configuration into a self standing greeting card in which a folded print portion stands substantially upright from a folded base portion, and
at least one code carried on said at least one sheet,
wherein said at least one code comprises an access code for accessing an associated electronic greeting media stored on an electronic device of said greeting card system; and
a controller configured to receive from a user device said access code and use said code to retrieve and transmit said electronic media associated with said card to the user device.

6. The greeting card system of claim 5, wherein said controller is further configured to receive the access code and associate said received access code with said electronic greeting media for said retrieval in response to receiving in said controller user entered instructions.

7. The greeting card system of claim 5, wherein the at least one code includes a portion that is only readable by a scanning device.

8. The greeting card system of claim 7, wherein the scanning device is selected from the group consisting of: a camera device; an image scanning device; a mobile telephone device; a smart phone device; a tablet device, a portable processor device;
a personal Computer (PC) devices; and a surveillance device.

9. A method for providing a customizable greeting card, the method comprising
configuring at least one sheet of material to be foldable from a flat configuration into a self standing greeting card in which a folded print portion stands substantially upright from a folded base portion, and
providing at least one code on said at least one sheet, wherein said at least one code comprises an access code.

10. The method of claim 9, further comprising
receiving sender generated media to be associated with the greeting card; and
associating the media with the access code.

11. The method of claim 10, further comprising
receiving access code scanned from greeting card received by recipient;
retrieving sender generated media associated with the greeting card; and
transmitting generated media associated with the card to a user device of the recipient.

12. A computer-implemented method for generating content for a customized greeting card, the method comprising,
receiving, from a presenting user, information for customizing the greeting card in a computer processing system;
programming, based on said received user information, by said computer processing system, content for the greeting card;
receiving, by said computer processing system, a user interface entered selection of content associated with the greeting card;
determining, by said computer processing system, a user intended to receive the content of the greeting card; and
transmitting said content for presenting on the user interface the content to the receiving user.

13. The method of claim 12, further comprising presenting said transmitted content to the receiving user via a device selected from the group consisting of: a mobile telephone device; a smart phone device; a tablet device, a portable processor device; and a personal Computer (PC) device.

14. An apparatus for customizing greeting cards, the apparatus comprising:
a memory storing instructions; and
one or more processors, wherein said instructions, when processed by the one or more processors, cause:
receiving user information in the apparatus; based on said received user information, programming, by said computer processing system, content for a greeting card;
receiving, by said computer processing system, a user interface entered selection of at least one identifier of the at least one code associated with the greeting card;
determining, by said computer processing system, the intended recipient of the greeting card content; and
transmitting said content for presenting the content of the greeting card on a user interface.

15. The apparatus of claim 14, further comprising presenting said content on the user interface of a device selected from the group consisting of: a mobile telephone device; a smart phone device; a tablet device, a portable processor device; and a personal Computer (PC) device.

16. A non-transitory computer-readable storage medium including instructions which, when processed by one or more processors, cause a greeting card code computing system to provide a method for providing a customizable greeting card, the method comprising:
receiving user information in the apparatus;
programming, based on said received user information, by said computer processing system, at least one code for associating content with said greeting card;
receiving, by said computer processing system, a user interface entered selection of at least one identifier of the code associated with the greeting card;
determining, by said computer processing system, the intended recipient of said greeting card content; and
transmitting said content for presenting, on the recipient's user interface, the content of the greeting card.

17. The medium of claim 16, further comprising presenting said content on the user interface of a device selected from the group consisting of: a mobile telephone device; a smart phone device; a tablet device, a portable processor device; and a personal Computer (PC) device.
